(19) United States
(12) Patent Application Publication
(10) Pub. No.: US 2016/0176023 A1
(43) Pub. Date: Jun. 23, 2016

(54) HAND TOOL WITH ROTATABLE FUNCTION UNIT

(71) Applicant: Shwu-Ruu Chern, Taichung (TW)

(72) Inventor: Shwu-Ruu Chern, Taichung (TW)

(21) Appl. No.: 14/578,278

(22) Filed: Dec. 19, 2014

(51) Int. Cl. B25B 13/06; B25B 13/56; B25B 23/00

(52) U.S. Cl. CPC B25B 13/06; B25B 23/0028; B25B 13/56

(57) ABSTRACT

A hand tool includes a handle and a head which has two extensions. A function unit is rotatably and pivotably connected between the two extensions. The function unit has a passage in the center thereof and multiple operation portions extend radially from the center of the function unit. Each operation portion has an operation hole. A first part and a second part are respectively mounted to two opposite sides of the function unit. A casing is securely coated to outside of the first and second parts. The operation holes are exposed in the periphery of the function unit so as to be connected with tool bits or objects.

### BACKGROUND OF THE INVENTION

1. Fields of the Invention

The present invention relates to a hand tool, and more particularly, to a hand tool having a rotatable function unit which has multiple operation holes. The function unit is coated with a protection casing.

2. Descriptions of Related Art

The conventional hand tools are made by metal which is heavy and generally has one function only. When the heavy metal-made hand tool drops to a hard floor from a height, it may be damaged and cannot be functionally operated.

The present invention intends to provide a hand tool having a rotatable function unit which has multiple operation holes, and a protection casing is coated to the function unit to eliminate the shortcomings mentioned above.

### SUMMARY OF THE INVENTION

The present invention relates to a hand tool and comprises a handle and a head extends from one end of the handle. The head has two extensions. A function unit is rotatably and pivotably connected between the two extensions. The function unit has a passage defined through the center thereof. Multiple operation portions extend radially from the center of the function unit. Each operation portion has an operation hole defined in the distal end thereof. A first part has a first hole located corresponding to the passage of the function unit. Multiple first recesses are defined in the first side of the first part. The first part is mounted to the first side of the function unit. The operation portions are partially accommodated in the first recesses correspondingly. A second part has a second hole located corresponding to the passage of the function unit. Multiple second recesses are defined in the second side of the second part. The second part is mounted to the second side of the function unit. The operation portions are partially accommodated in the second recesses correspondingly. A casing is securely coated to outside of the first and second parts.

Preferably, one of the operation holes is a hexagonal hole.

Preferably, the first part, the second part and the casing have different colors from each other.

Preferably, the casing is coated to the first and second parts by way of plastic injection molding.

The primary object of the present invention is to provide a hand tool that has a casing which protects the function unit.

Another object of the present invention is to provide a hand tool which has attractive an outer appearance.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the function unit of the hand tool of the present invention;

FIG. 2 is a perspective view to show the function unit of the hand tool of the present invention;

FIG. 3 is a top view of the function unit of the hand tool of the present invention;

FIG. 4 is a cross sectional view, taken along line 4-4 in FIG. 3, and

FIG. 5 shows the hand tool with the function unit of the present invention.

### DETAILED DESCRIPTION OF THE PREFERRED EMBODIMENT

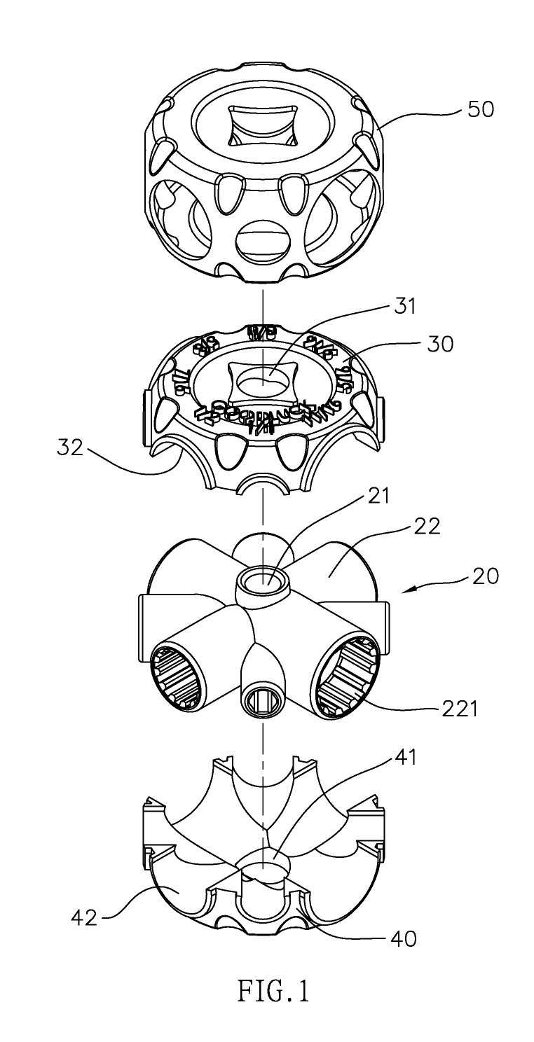

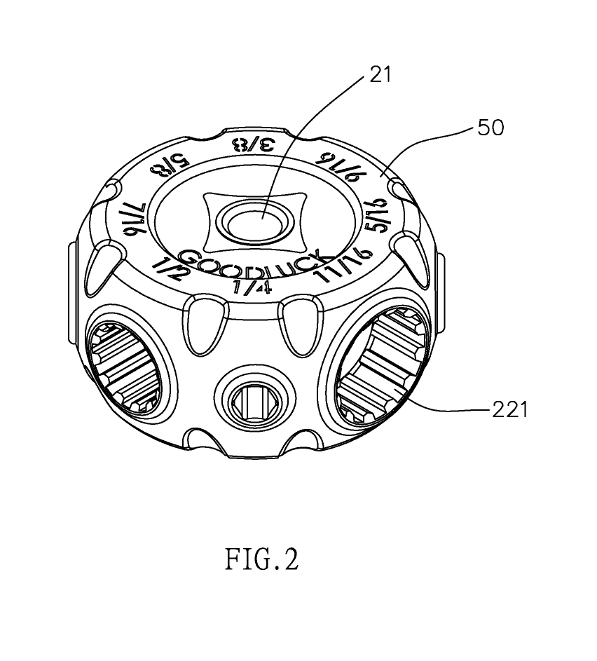

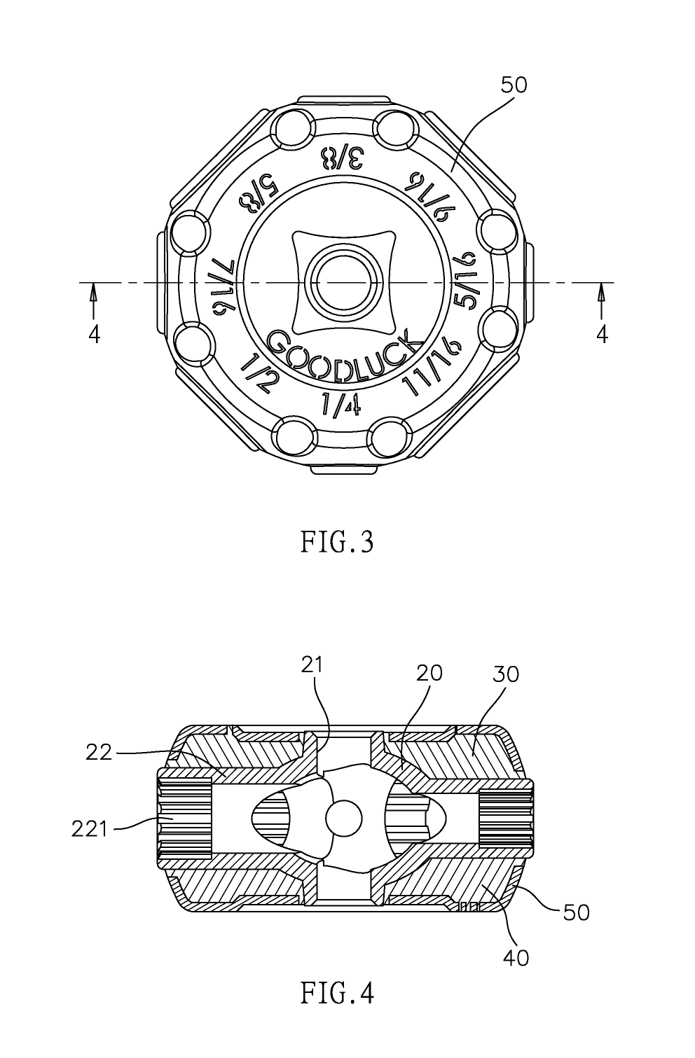

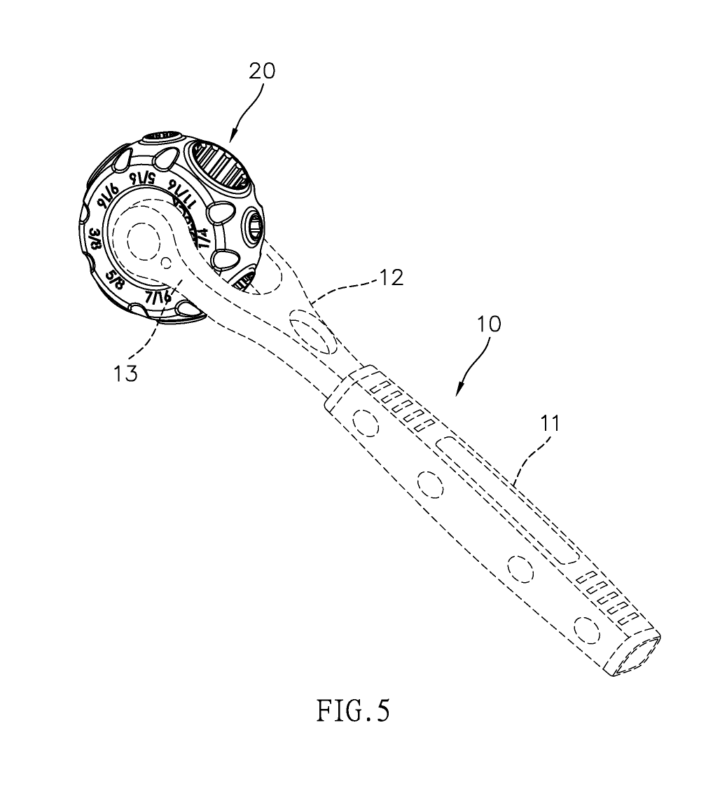

Referring to FIGS. 1 to 5, the hand tool 10 of the present invention comprises a handle 11 and a head 12 extending from one end of the handle 11. The head 12 has two extensions 13 extending therefrom. A function unit 20 is rotatably and pivotably connected between the two extensions 13. The function unit 20 has a passage 21 defined through the center thereof. Multiple operation portions 22 extend radially from the center of the function unit 20, and each operation portion 22 has an operation hole 221 defined in the distal end thereof. The operation holes 221 may have different shapes and functions. At least one of the operation holes 221 is a hexagonal hole.

A first part 30 has a first hole 31 located corresponding to the passage 21 of the function unit 20. Multiple first recesses 32 are defined in the first side of the first part 30. The first part 30 is mounted to the first side of the function unit 20. The operation portions 22 are partially accommodated in the first recesses 32 correspondingly. A second part 40 has a second hole 41 located corresponding to the passage 21 of the function unit 20. Multiple second recesses 42 are defined in the second side of the second part 40. The second part 40 is mounted to the second side of the function unit 20. The operation portions 22 are partially accommodated in the second recesses 42 correspondingly. A casing 50 is securely coated to outside of the first and second parts 30, 40 by way of plastic injection molding. Preferably, the first part 30, the second part 40 and the casing 50 have different colors from each other. The operation holes 221 of the operation portions 22 are located and exposed in the periphery of the function unit 20 so that different tool bits or objects can be engaged with the operation holes 221.

When using the hand tool, the tool bit or object is engaged with one of the operation holes 221, and the handle 11 is rotated in the direction that is perpendicular to the first and second sides of the function unit 20 so as to output torque.

The casing 50 and the first and second parts 30, 40 form a protection cover to the function unit 20 such that the function unit 20 is protected from being damaged even if the hand tool drops from a height to a hard floor.

While we have shown and described the embodiment in accordance with the present invention, it should be clear to those skilled in the art that further embodiments may be made without departing from the scope of the present invention.

What is claimed is:

1. A hand tool comprising:
a handle and a head extending from one end of the handle, the head having two extensions;
a function unit rotatably and pivotably connected between the two extensions, the function unit having a passage defined through a center thereof, multiple operation portions extending radially from the center of the function unit, each operation portion having an operation hole defined in a distal end thereof;
a first part having a first hole located corresponding to the passage of the function unit, multiple first recesses defined in a first side of the first part, the first part mounted to a first side of the function unit, the operation portions being partially accommodated in the first recesses correspondingly;
a second part having a second hole located corresponding to the passage of the function unit, multiple second recesses defined in a second side of the second part, the second part mounted to a second side of the function unit, the operation portions being partially accommodated in the second recesses correspondingly, and
a casing securely coated to outside of the first and second parts.

2. The hand tool as claimed in claim 1, wherein one of the operation holes is a hexagonal hole.

3. The hand tool as claimed in claim 1, wherein the first part, the second part and the casing have different colors from each other.

4. The hand tool as claimed in claim 1, wherein the casing is coated to the first and second parts by way of plastic injection molding.
